(19) United States
(12) Patent Application Publication
(10) Pub. No.: US 2019/0230895 A1
(43) Pub. Date: Aug. 1, 2019

(54) Pet Combination House that is Assembled and Disassembled Quickly to Facilitate Storage

(71) Applicants: Chih-Hung Lin, Chiayi City (TW); Li- Wen Shen, Chiayi City (TW)

(72) Inventors: Chih-Hung Lin, Chiayi City (TW); Li- Wen Shen, Chiayi City (TW)

(21) Appl. No.: 15/884,432

(22) Filed: Jan. 31, 2018

(51) Int. Cl. A01K 1/03; A01K 1/035

(52) U.S. Cl. CPC A01K 1/033; A01K 1/035

(57) ABSTRACT

A pet combination house includes a housing and a connecting unit. The housing includes a plurality of plates, with a folding line being formed at a connection of two plates. The plates are folded upward along the folding line and are connected together to construct the housing. Some of the plates have a side respectively provided with a fastening member. The fastening members of the plates are detachably combined together in pairs when the housing is disposed at the three-dimensional state. At least one of the plates is provided with an opening. At least one of the plates has a face provided with a plurality of apertures. The connecting unit includes a plurality of retaining members mounted on the plates and aligning with the apertures, and a plurality of connecting members mounted in the apertures and retained by the retaining members.

### BACKGROUND OF THE INVENTION

### 1. Field of the Invention

The present invention relates to a combination house and, more particularly, to a pet combination house for rest, playing and activity of pets.

### 2. Description of the Related Art

A conventional pet combination framework comprises a cube and a plurality of boards mounted on six faces of the cube. Each of the six faces of the cube is provided with a first through hole. Each of the boards is provided with a second through hole aligning with the respective first through hole of the cube. Thus, the cube and the boards construct a three-dimensional unit. Multiple connecting rings are mounted on multiple three-dimensional units, with each of the connecting rings being connected between any two adjacent three-dimensional units. Thus, the multiple three-dimensional units construct a pet labyrinth assembly so that the pets may move between the multiple three-dimensional units, to have an amusement effect in the pet labyrinth assembly. However, the cube is formed integrally by cutting, so that the cube occupies a large space and cannot be folded to reduce the whole volume, thereby causing inconvenience storage, packaging and transportation of the conventional pet combination framework.

### BRIEF SUMMARY OF THE INVENTION

The primary objective of the present invention is to provide a pet combination house that is assembled and disassembled quickly to facilitate storage and transportation.

In accordance with the present invention, there is provided a pet combination house comprising a housing and a connecting unit mounted on the housing. The housing includes a plurality of plates juxtaposed to each other, with a folding line being formed at a connection of any two of the plates. The plates are folded upward along the folding line and are connected together to construct the housing with a three-dimensional state. Some of the plates have a side respectively provided with a fastening member, with the folding line being formed at a connection of the fastening member and the respective plate. The fastening members of the plates are detachably combined together in pairs when the housing is disposed at the three-dimensional state. At least one of the plates is provided with an opening. At least one of the plates has a face provided with a plurality of apertures. The connecting unit includes a plurality of retaining members mounted on the plates and aligning with the apertures, and a plurality of connecting members mounted in the apertures and retained by the retaining members.

According to the primary advantage of the present invention, the housing is assembled and disassembled easily and quickly to facilitate the user assembling and disassembling the pet combination house.

According to another advantage of the present invention, the housing is detached and folded when not in use, thereby reducing the volume of the pet combination house, and thereby facilitating storage, packaging and transportation of the pet combination house.

According to a further advantage of the present invention, multiple housings are combined together, and are arranged to present different models, thereby enhancing the diversity and variation of the pet combination house.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view showing expansion of a pet combination house in accordance with the preferred embodiment of the present invention.

FIG. 2 is a perspective view showing folding up of the pet combination house in accordance with the preferred embodiment of the present invention.

FIG. 3 is a schematic perspective view showing two housings in accordance with the preferred embodiment of the present invention.

FIG. 4 is a perspective view showing combination of the two housings as shown in FIG. 3.

FIG. 5 is a perspective view showing combination of multiple housings in accordance with the preferred embodiment of the present invention.

FIG. 6 is a schematic perspective view showing a linking structure between the housings.

### DETAILED DESCRIPTION OF THE INVENTION

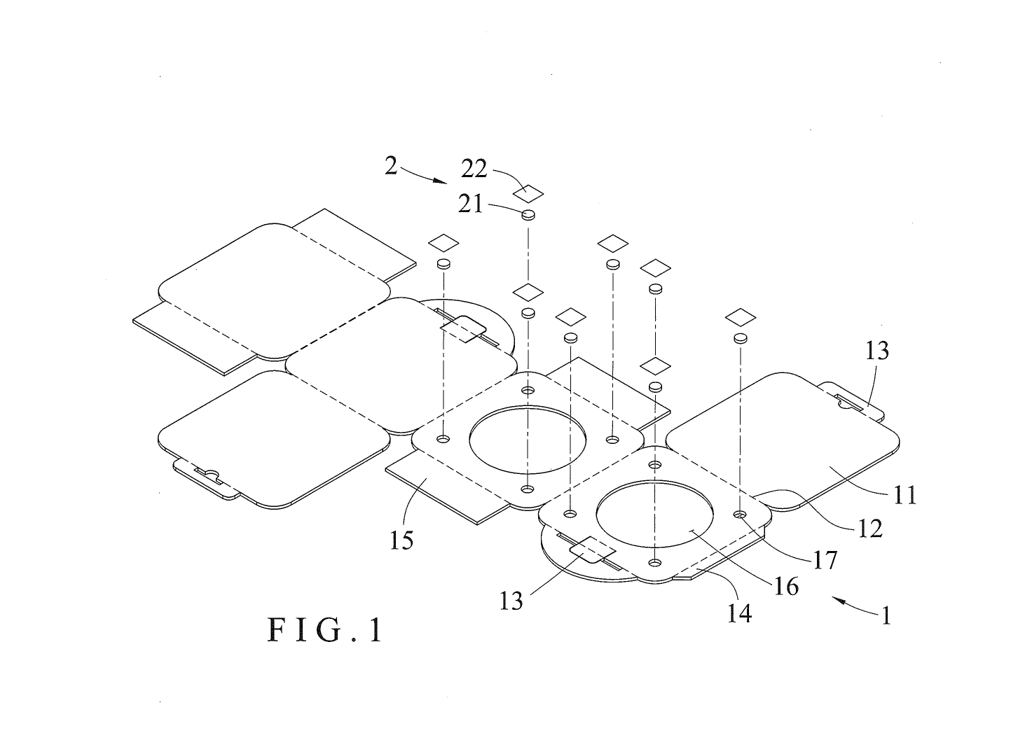

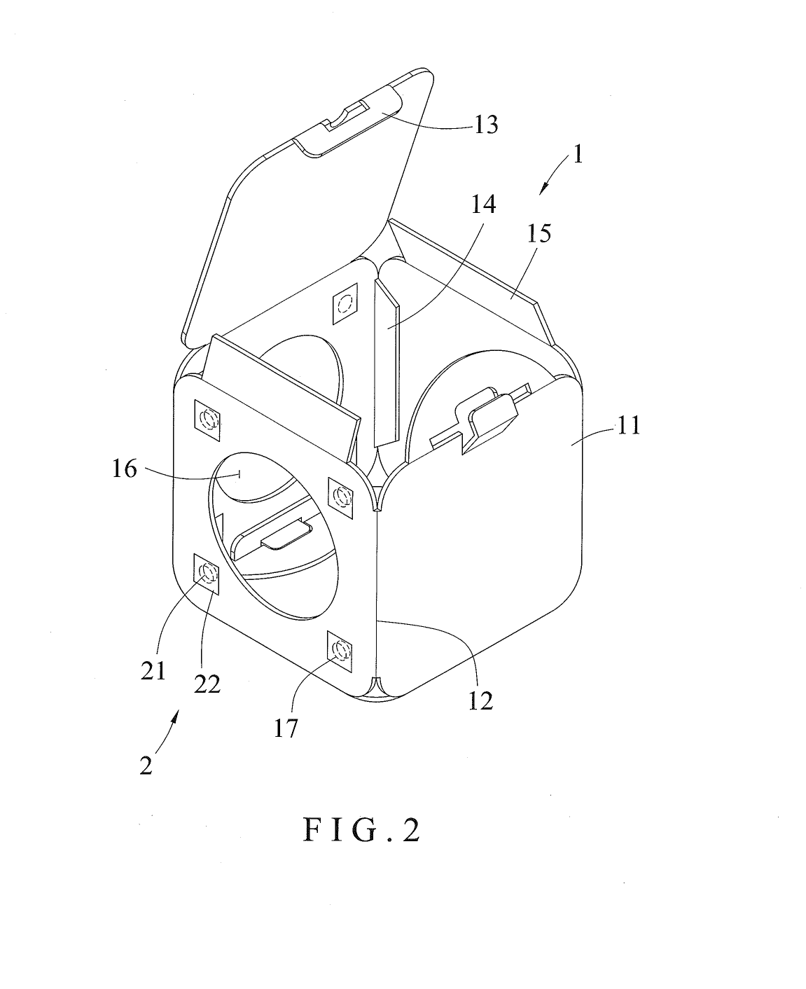

Referring to the drawings and initially to FIGS. 1 and 2, a pet combination house in accordance with the preferred embodiment of the present invention comprises a housing 1 and a connecting unit 2 mounted on the housing 1.

The housing 1 includes a plurality of plates 11 juxtaposed to each other, with a folding line 12 being formed at a connection of any two of the plates 11. The plates 11 are folded upward along the folding line 12 and are connected together to construct the housing 1 with a three-dimensional state. Some of the plates 11 have a side respectively provided with a fastening member 13, with the folding line 12 being formed at a connection of the fastening member 13 and the respective plate 11. The fastening members 13 of the plates 11 are detachably combined together in pairs when the housing 1 is disposed at the three-dimensional state. At least one of the plates 11 is provided with an opening 16. At least one of the plates 11 has a face provided with a plurality of apertures 17. Preferably, at least one of the plates 11 is provided with the opening 16 and the apertures 17 simultaneously.

The connecting unit 2 includes a plurality of retaining members 22 mounted on the plates 11 and aligning with the apertures 17, and a plurality of connecting members 21 mounted in the apertures 17 and retained by the retaining members 22.

In the preferred embodiment of the present invention, the plates 11 of the housing 1 are formed integrally.

In the preferred embodiment of the present invention, the housing 1 is made of paper or plastic material.

In the preferred embodiment of the present invention, each of the plates 11 of the housing 1 has fillet corners. Thus, when the housing 1 is disposed at a three-dimensional state, the housing 1 has hollow corners to enhance the ventilating effect, and to prevent cause danger to the pets.

In the preferred embodiment of the present invention, at least one of the plates 11 has a side provided with a fixed piece 14 secured to an adjacent plate 11 when the housing 1 is disposed at the three-dimensional state. The folding line 12 is formed at a connection of the fixed piece 14 and the respective plate 11. Thus, the fixed piece 14 connects two adjacent plate 11 securely.

In the preferred embodiment of the present invention, some of the plates 11 are respectively provided with at least one side piece 15, and the folding line 12 is formed at a connection of the at least one side piece 15 and the respective plate 11.

In practice, the housing 1 includes six plates 11 each of which has a square shape, so that the housing 1 has a cube shape. Alternatively, each of the plates 11 has a rectangular or triangular shape. Alternatively, the plates 11 have different geometric shapes. For example, three of the plates 11 have square shape, and two of the plates 11 have regular triangular shape, so that the housing 1 forms a triangular column. The housing 1 is formed by a single paper board which is cut to form the plates 11 integrally. Alternatively, the housing 1 is formed by multiple paper boards which are cut respectively and are then connected. The paper boards are connected directly or connected by the fixed piece 14, or connected by the fastening members 13. The plates 11 and the at least one side piece 15 may have a skeleton and an outer layer (such as cloth) covering the skeleton. The outer layers are connected mutually by sewing to construct the housing 1. The fastening members 13 of the plates 11 construct a mortise joint which includes a tenon and a mortise. Besides, two of the plates 11 are provided with the opening 16 and the apertures 17. Alternatively, each of the plates 11 is provided with the opening 16 and the apertures 17. Alternatively, only some of the plates 11 are provided with the opening 16 and the apertures 17. Each of the connecting members 21 of the connecting unit 2 is a magnet. Alternatively, each of the connecting members 21 of the connecting unit 2 is a snap fastener. Each of the retaining members 22 of the connecting unit 2 is an adhesive tape stuck to the respective plate 11 and the respective connecting member 21.

In assembly, the plates 11, the fastening members 13, the fixed piece 14 and the side pieces 15 are bent and folded up along the folding line 12, so that the housing 1 is disposed at a three-dimensional state. Then, the fixed piece 14 is secured to an adjacent plate 11, such as by adhesive. Then, the fastening members 13 of the plates 11 are combined together in pairs to construct the housing 1 of the three-dimensional state. When the connecting unit 2 is mounted on the housing 1, the connecting members 21 are mounted in the apertures 17. Then, the retaining members 22 are secured on the plates 11 and align with the apertures 17 to retain the connecting members 21 in the apertures 17.

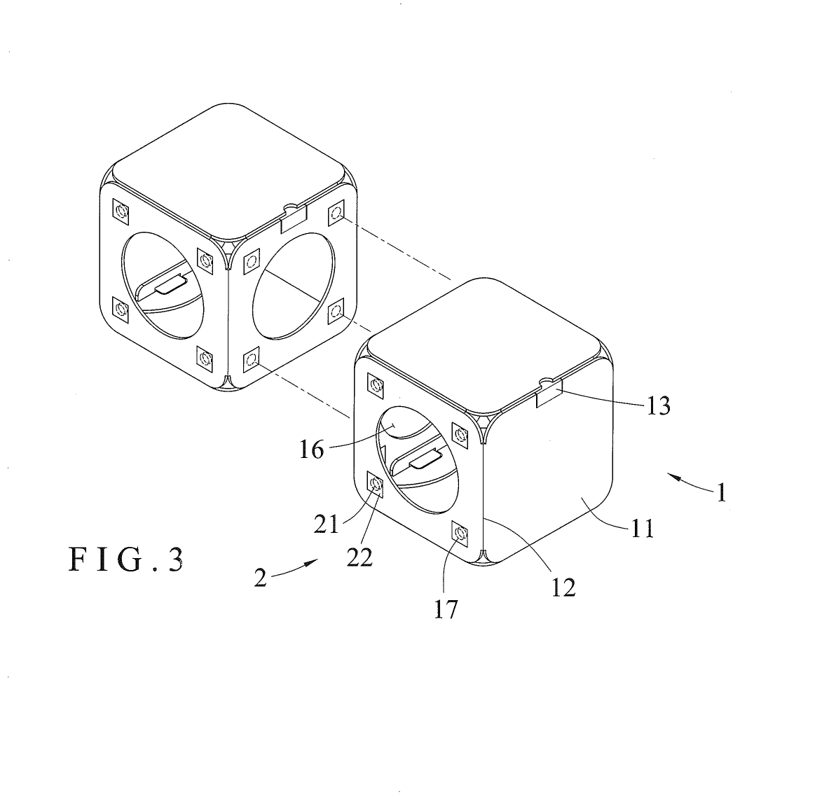

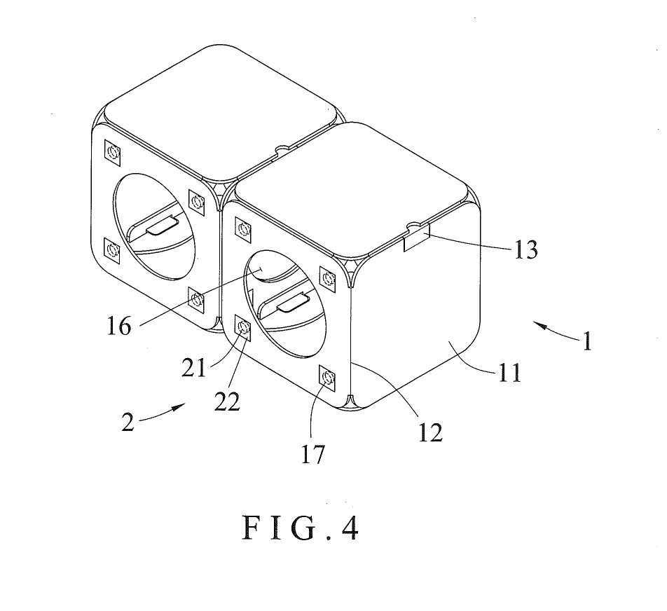

Referring to FIGS. 3 and 4, two housings 1 are combined by connection of the connecting members 21. At this time, the openings 16 of the two housings 1 correspond to and align with each other, so that the two housings 1 are connected by the openings 16. In such a manner, the pets moves freely between the housings 1 through the openings 16.

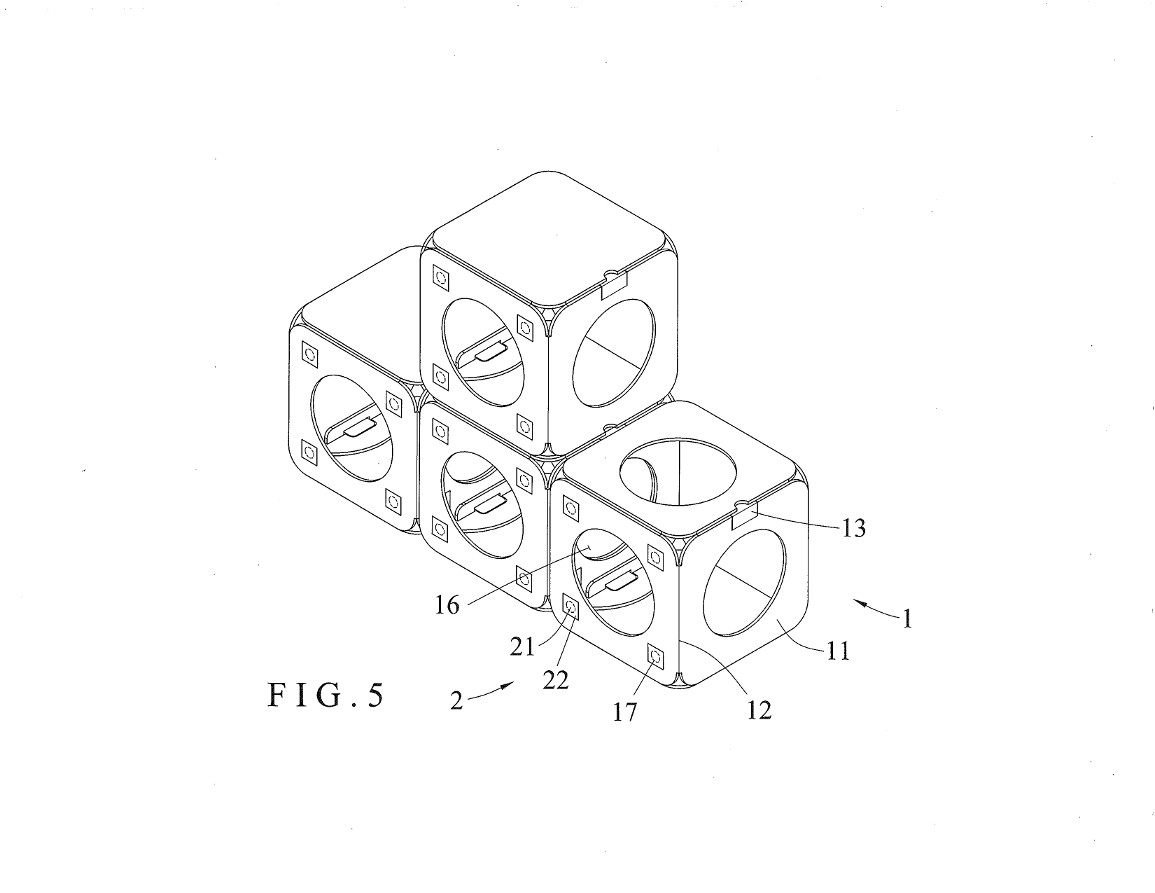

Referring to FIG. 5, multiple housings 1 are combined by connection of the connecting members 21 and may be arranged in diverse manners, thereby enhancing the variation and amusement of the pet combination house.

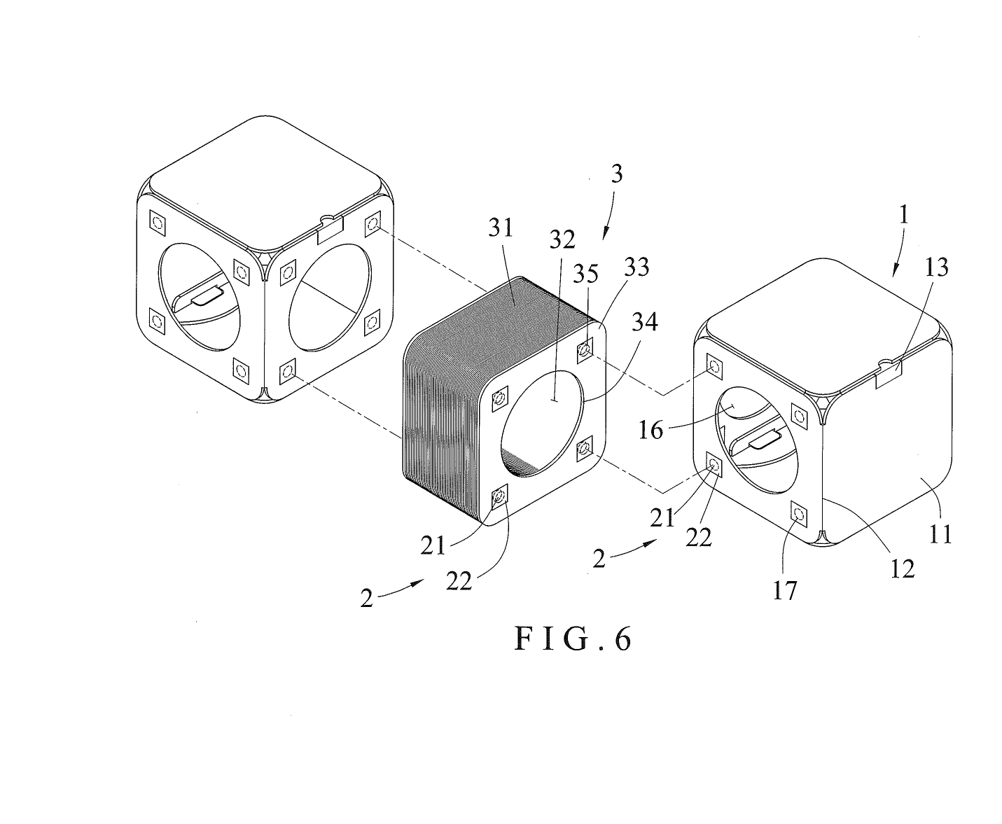

Referring to FIG. 6, the pet combination house further comprises at least one linking structure 3 including a junction 31 which has an interior provided with a passage 32. The junction 31 has two ends each provided with a plurality of receiving holes 35. The retaining members 22 of the connecting unit 2 are mounted on the junction 31 and align with the receiving holes 35, and the connecting members 21 of the connecting unit 2 are mounted in the receiving holes 35 and retained by the retaining members 22. The connecting members 21 in the receiving holes 35 of the at least one linking structure 3 are connected with the connecting members 21 in the apertures 17 of the housing 1, so that the at least one linking structure 3 is connected with the housing 1. Thus, the at least one linking structure 3 is sandwiched between two housings 1, so that the two housings 1 are connected by the at least one linking structure 3, to facilitate the pets moving between the two housings 1.

In the preferred embodiment of the present invention, the at least one linking structure 3 further includes two connecting planks 33 secured on the two ends of the junction 31. Each of the two connecting planks 33 has an interior provided with a through hole 34 connected to the passage 32 of the junction 31. The receiving holes 35 are formed in a face of each of the two connecting planks 33. The retaining members 22 of the connecting unit 2 are mounted on each of the two connecting planks 33.

In the preferred embodiment of the present invention, the junction 31 has a retractable arrangement.

In the preferred embodiment of the present invention, the junction 31 is made of honeycomb paper.

Accordingly, the housing 1 is assembled and disassembled easily and quickly to facilitate the user assembling and disassembling the pet combination house. In addition, the housing 1 is detached and folded when not in use, thereby reducing the volume of the pet combination house, and thereby facilitating storage, packaging and transportation of the pet combination house. Further, multiple housings 1 are combined together, and are arranged to present different models, thereby enhancing the diversity and variation of the pet combination house.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A pet combination house comprising:
a housing; and
a connecting unit mounted on the housing;
wherein:
the housing includes a plurality of plates juxtaposed to each other, with a folding line being formed at a connection of any two of the plates;
the plates are folded upward along the folding line and are connected together to construct the housing with a three-dimensional state;
some of the plates have a side respectively provided with a fastening member, with the folding line being formed at a connection of the fastening member and the respective plate;
the fastening members of the plates are detachably combined together in pairs when the housing is disposed at the three-dimensional state;
at least one of the plates is provided with an opening;
at least one of the plates has a face provided with a plurality of apertures; and
the connecting unit includes a plurality of retaining members mounted on the plates and aligning with the apertures, and a plurality of connecting members mounted in the apertures and retained by the retaining members.

2. The pet combination house of claim 1, wherein the plates of the housing are formed integrally.

3. The pet combination house of claim 1, wherein the housing is made of paper or plastic material.

4. The pet combination house of claim 1, wherein each of the plates of the housing has fillet corners.

5. The pet combination house of claim 1, wherein:
at least one of the plates has a side provided with a fixed piece secured to an adjacent plate when the housing is disposed at the three-dimensional state; and
the folding line is formed at a connection of the fixed piece and the respective plate.

6. The pet combination house of claim 1, wherein some of the plates are respectively provided with at least one side piece, and the folding line is formed at a connection of the at least one side piece and the respective plate.

7. The pet combination house of claim 1, further comprising:
at least one linking structure including a junction which has an interior provided with a passage;
wherein:
the junction has two ends each provided with a plurality of receiving holes;
the retaining members of the connecting unit are mounted on the junction and align with the receiving holes;
the connecting members of the connecting unit are mounted in the receiving holes and retained by the retaining members; and
the connecting members in the receiving holes of the at least one linking structure are connected with the connecting members in the apertures of the housing, so that the at least one linking structure is connected with the housing.

8. The pet combination house of claim 7, wherein:
the at least one linking structure further includes two connecting planks secured on the two ends of the junction;
each of the two connecting planks has an interior provided with a through hole connected to the passage of the junction;
the receiving holes are formed in a face of each of the two connecting planks; and
the retaining members of the connecting unit are mounted on each of the two connecting planks.

9. The pet combination house of claim 7, wherein the junction has a retractable arrangement.

10. The pet combination house of claim 9, wherein the junction is made of honeycomb paper.
